(19) United States
(12) Patent Application Publication
(10) Pub. No.: US 2014/0310306 A1
(43) Pub. Date: Oct. 16, 2014

(54) System And Method For Pattern Recognition And User Interaction

(71) Applicant: 5D Innovations, LLC, West Henrietta, NY (US)

(72) Inventors: Mark Nicholas Sawczuk, Shelburne, VT (US); David Jeffrey Hawks, Rochester, NY (US); Paul Edward Spencer, Livonia, NY (US); Anthony Layton Turner, Rochester, NY (US)

(73) Assignee: 5D Innovations, LLC, West Henrietta, NY (US)

(21) Appl. No.: 14/247,202

(22) Filed: Apr. 7, 2014

Related U.S. Application Data
(60) Provisional application No. 61/812,226, filed on Apr. 15, 2013.

(51) Int. Cl. G06F 17/30

(52) U.S. Cl. CPC G06F 17/30684
USPC 707/769

(57) ABSTRACT

A computer based system for pattern recognition and user interaction that assists users with extracting value from their data. The system for pattern recognition and user interaction converts text based queries into usable mathematical models and software code and provides hierarchical tracing of ongoing interrogation by way of text based queries and related answers while also providing suggestions for future queries to the user.

### CROSS-REFERENCE TO RELATED PATENT APPLICATIONS

This application claims priority to U.S. Patent Application Ser. No. 61/812,226 filed Apr. 15, 2013 entitled “System And Method For Pattern Recognition And User Interaction” by Mark Nicholas Sawezuk. David Jeffrey Hawks. Paul Edward Spencer and Anthony Layton Turner, the entire disclosure of which is incorporated herein by reference.

### BACKGROUND OF THE INVENTION

1. Field of the Invention

The present invention relates generally to data processing systems and methods, and more particularly, relates to a system and method for pattern recognition and user interaction.

2. Description of Related Art

With the ongoing growth and proliferation of computer hardware and software, data is being collected and stored at an ever increasing rate. Data sources are becoming increasingly plentiful and diverse as the means to collect data continues to be easier and lower cost. With software applications collecting data either through user input or by way of transactional or sensor based inputs, most professionals are inundated with data that they have little ability to extract meaning from. The vast quantities of data being collected and stored each day are oftentimes not utilized at all, or are underutilized or even misused. Most professionals lack the time or resources to create custom programming to delve into this collected data and extract meaningful information. In addition, many professionals do not even know where to begin with their data or what questions should be asked to extract true value from the data they have collected. Consequently, much data lies in storage without ever seeing benefits from its collection. Data often contains information that could be valuable to a business or other entity, but without the ability to extract the hidden meaning contained within the data, it merely lies in storage taking up resources to store and maintain.

What is needed is a system and method to extract valuable information from data by taking text entries and turning them into usable mathematical models and software code. What is also needed is a system and method to dialog with data through a series of question and answer interrogations. Throughout the dialog process, a form of tracking or tracing to visually represent the back and forth question and answer dialog would further be beneficial. What is also needed is a system and method for creating suggestions during this dialog process.

It is therefore an object of the present invention to provide a computer based system and method for pattern recognition and user interaction where the user enters queries by way of text. It is another object of the present invention to provide a computer based system and method for pattern recognition and user interaction where the user dialogs with data through a series of question and answer interrogations. It is another object of the present invention to provide a computer based system and method for pattern recognition and user interaction where hierarchical tracing is employed to provide a visual representation of question and answer interrogations. It is yet another object of the present invention to provide a computer based system and method for pattern recognition and user interaction where suggestions are created during the dialog between the user and the data.

These and other objects of the present invention are described in the detailed specification, claims and drawings contained herein.

### BRIEF SUMMARY OF THE INVENTION

In accordance with the present invention, there is provided a computer based method and system for pattern recognition and user interaction, the method comprising the steps of providing input data on a computer having a processor, memory and computer readable media and storing said input data on the computer readable media; applying a mathematical model to the input data on the computer; receiving on the computer through a human interface device a text based question; converting the text based question to a machine language query on the computer; applying the machine language query to the input data on the computer to obtain a subset of the input data; presenting the question and the obtained input data subset as an answer in a hierarchical object on a computer display; providing on the computer a means for receiving a further text based question directed at the input data subset; converting the further text based question to a machine language query on the computer; applying the machine language query to the input data subset on the computer to obtain a further subset of the input data; presenting the question and the obtained further subset of the input data subset as an answer in a further hierarchical object on the computer display; and linking the hierarchical objects with linear traces that provide a visual representation of questions being asked of information provided as an answer in a previous object.

The system for pattern recognition and user interaction further comprises a language processing component, a hierarchical tracing component, and a data input function where a mathematical model creates a numeric, text, or graphical output on a computer display that has a hierarchical construct.

The foregoing paragraph has been provided by way of introduction, and is not intended to limit the scope of the invention as described and envisioned herein.

### BRIEF DESCRIPTION OF THE DRAWINGS

The invention will be described by reference to the following drawings, in which like numerals refer to like elements, and in which:

FIG. 1 is a functional block diagram depicting the major components of the system for pattern recognition and user interaction;

FIG. 2 is an input output diagram of the system for pattern recognition and user interaction;

FIG. 3 is an exemplary network diagram of the present invention;

FIG. 4 is a flowchart depicting a typical input to output process of the present invention;

FIG. 5 is a screenshot depicting a login page;

FIG. 6 is a screenshot depicting a home page of the present invention;

FIG. 7 is a screenshot depicting a project creation page;

FIG. 8 is a screenshot depicting data entry into the project creation page;

FIG. 9 is a screenshot depicting the selection of a data source file;

FIG. 10 is a screenshot depicting the selection of a specific data source file;

FIG. 11 is a screenshot depicting the data source file being selected;

FIG. 12 is a screenshot depicting the data source file being uploaded;

FIG. 13 is a screenshot depicting the data source file after upload, and ready for analysis;

FIG. 14 is a screenshot depicting a project analysis selected;

FIG. 15 is a screenshot depicting data statistics selected;

FIG. 16 is a screenshot depicting analysis opportunities and data statistics;

FIG. 17 is a screenshot depicting data being displayed with a chosen data set;

FIG. 18 is a screenshot depicting statistics for a specific parameter;

FIG. 19 is a screenshot depicting statistics of a particular parameter chosen;

FIG. 20 is a screenshot depicting records that fall between a range;

FIG. 21 is a screenshot depicting the results of records falling between a range;

FIG. 22 is a screenshot depicting records within a range and new exploration opportunities;

FIG. 23 is a screenshot depicting auto-plotting of data;

FIG. 24 is a screenshot depicting auto generated exploration opportunities;

FIG. 25 is a screenshot depicting automatic finding of correlated items;

FIG. 26 is a screenshot depicting automatic performance of a complex modeling prognostic;

FIG. 27 is a screenshot depicting computation of a predictive analytics prognostic;

FIG. 28 is a screenshot depicting an explanation of predictive analytics;

FIG. 29 is a screenshot depicting the computation of predictive analytics model parameters;

FIG. 30 is a screenshot depicting predictive analytics statistics;

FIG. 31 is a screenshot depicting performance statistics of a predictive analytics model;

FIG. 32 is a screenshot depicting an automated ‘group by’ plot; and

FIG. 33 is a screenshot depicting automated “group by” data;

The present invention will be described in connection with a preferred embodiment, however, it will be understood that there is no intent to limit the invention to the embodiment described. On the contrary, the intent is to cover all alternatives, modifications, and equivalents as may be included within the spirit and scope of the invention as defined by this specification, claims and drawings contained herein.

### DESCRIPTION OF THE PREFERRED EMBODIMENTS

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

For a general understanding of the present invention, reference is made to the drawings. In the drawings, like reference numerals have been used throughout to designate identical elements.

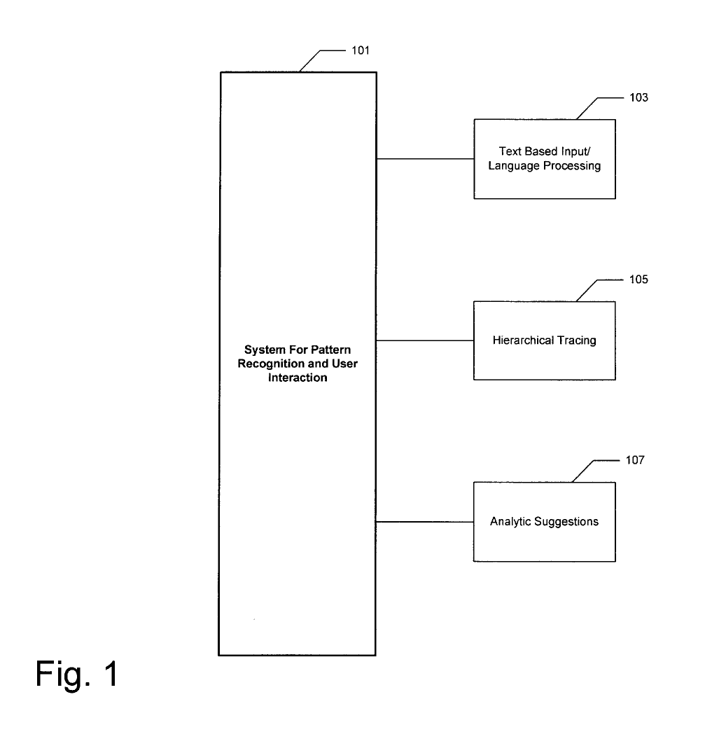

FIG. 1 is a functional block diagram depicting the major components of the system for pattern recognition and user interaction. Referring to FIG. 1, the system for pattern recognition and user interaction 101 contains various components. The components depicted in FIG. 1 are representative only, and omissions, substitutions and additions to these exemplary components may be performed without departing from the spirit and broad scope of the present invention and its various embodiments described and illustrated herein.

In FIG. 1, the system for pattern recognition and user interaction 101 allows a user to enter questions or queries using text based inputs such as free form text and language processing such as natural language processing 103. This language processing component converts a user's text entry into a query that targets input data. In some embodiments of the present invention, the query is displayed as a suggestion in a created object. The queries relate to data that has been uploaded or otherwise conveyed to the system for pattern recognition and user interaction and the use of text based entries such as free form text frees the user from structuring queries in a programming language. Once the query is entered and a response or responses are received from the system, hierarchical tracing 105 is employed so that when entering a dialogue of queries, the user can graphically view the dialogue of queries. This provides the user with a solid view of the information being obtained from the data set being analyzed. The hierarchical tracing component creates a series of objects that contain both a question and an answer, the objects being connected through linear traces that provide a visual representation on a computer display of questions being asked of information provided as an answer in a previous object, creating a geometric hierarchical representation of a question and answer dialogue between a user and the system for pattern recognition and user interaction. A hierarchical object selector is also provided in some embodiments of the present invention where a user takes an action to select a hierarchical object that results in the selected hierarchical object being displayed on a computer monitor with an appearance that is different than non-selected hierarchical objects. Each object is a geometric shape that is linked or otherwise connected to other objects in a hierarchy such as a geometric hierarchical representation, a tree, a list, or the like. The geometric hierarchical representation of objects with linear traces interconnecting each object provide a visual and spatial representation on a computer display of questions being asked of information that was provided as an answer as displayed in a previous object, thus providing a structure to the question and answer dialogue between a user and the system for pattern recognition and user interaction. An answer or answers may be displayed within an object where the answer may be in the form of a graph, a table, a mathematical expression, the word yes, the word no, text, numbers, symbols, or the like.

A hierarchical tracing user interface for display on a computer screen is also provided.

The hierarchical tracing user interface comprises a text user input field; a plurality of hierarchical objects interconnected through linear traces; each hierarchical object having a geometric shape and containing a prompt indicating a question and a prompt indicating an answer; wherein information obtained from text entered in the user input field is displayed after the prompt indicating a question in at least one hierarchical object and a subset of input data is displayed after the prompt indicating an answer in at least one hierarchical object; and wherein the interconnection of hierarchical objects containing a question component and an answer component with linear traces provides a visual representation of questions being asked of information provided as an answer in a previous object.

Further, analytic suggestions 107 are provided to the user during this dialogue to provide additional potential uses for the data that is being analyzed. In some embodiments of the present invention, a query suggestion component is provided to prompt a user to consider various questions regarding input data. The query suggestion component in some embodiments of the present invention further comprises filter suggestions to filter the data that has been provided. In some embodiments of the present invention, the query suggestion component further comprises suggestions of various plots and trends that a user may select. Additionally, in some embodiments of the present invention, the query suggestion component further comprises suggestions of various statistics formulas, results, calculations, or the like. Predictions and other statistical models, formulas and expressions may also be included in the query suggestion component in various embodiments of the present invention.

The present invention creates a catalog of possible querying, analytical, statistical, modeling, and graphical operations that can be performed with a user's data, and represents these possible queries as language expressions such as natural language expressions for the purpose of suggesting to the user the different tasks that can be performed to extract value from their data. An input field is used to take a users input text to automatically identify keywords, names of columns, tables, data sources, values contained within the tables, and semantic references to the user and to automatically filter down the list of possible expressions from the created catalog. When selecting a language expression, the system for pattern recognition and user interaction 101 executes an analysis that the language expression has abstracted. This method guides the user and provides an understanding of all of the “what-if” questions that can be answered with the user's data using, for example, natural language and allows the user to quickly identify what it is they would like answered.

The system for pattern recognition and user interaction displays each request to analyze the data as a question and answer node in a Tree-View display (a question and answer tree or a hierarchical trace). The Tree-View display shows a graphical relation that signifies the parent-child chronology of analytical tasks that must be accomplished prior to answering a particular query. This method creates a unique and novel view that is used to automatically document the chronology of questions (or analytical processes) to show the user ‘how we got there’ and to articulate the feel of a “dialogue” with data. Using a unique and novel ‘tree’ structure, a user can quickly see how their questions were asked, in which order, and the associated data that was used at any step. This hierarchical tracing method is displayed graphically by way of a user interface that may be on a monitor, display, or the like. The answers shown in the node may include, for example, text, tables, and plots. The answers provided in the Q&A Tree View are also updated in real-time asynchronously so the user can see how live streaming data is captured by their Q&A Tree View.

The system for pattern recognition and user interaction includes fully automated language processing recognition such as natural language processing recognition. Unlike most business intelligence systems, the present invention does not require the user to directly specify a query and define a view in order to perform an analysis. At run-time, when the user specifies a language expression, the system automatically determines the centroid of the query, the order in which the joins must occur to the center table in the query, and automatically performs aggregate analysis on tables that will be joined to the primary table which have a 1:N relationship. This allows the user to ask a question using the information that is important to the specific question they want answered, and is not concerned with building a view first before using analytical tools to answer the question. By automating the identification of which table needs to be the centroid of the query (centroid is the table specified by the main “FROM” clause in the query) when the user asks a question which requires information spanning more than one table, the system will remove the potential error on the end part of the user performing the join in the wrong direction. (For example, in a table containing demographics on 100 patients, and a table with bypass information for grafts for those 100 patients, the two questions:
1) Which demographic and procedural characteristics predict that a graft will fail?
2) Which demographic and procedural characteristics predict that a patient will experience a failed graft?
   are statistically very different questions. The first requires knowledge that the demographic table will be LEFT JOIN to the bypass table, and the second question requires first aggregating the graft information by patient from the bypass table, then LEFT JOIN that to the patient table. The fields used in both questions are exactly the same, and the model+hypothesis test used for each case is identical, however not being able to reverse engineer the proper order of the query and use of the aggregate would have caused an incorrect result and only a PhD statistician or expert informaticist would have identified this.

When the user selects a language expression such as a natural language expression from the suggestions in the system or alternatively types in a manual input, the system automatically builds code dynamically to execute querying, modeling, and visualization routines. The system uses expert systems to automatically build all the underlying code at run-time, such that the user does not have to select or build complex mathematical models graphically, nor do they have to program any code, nor prepare views and queries before performing the analysis. The system takes what the user types in the query box and automatically turns that into actionable, processable code. The expert system of the present invention understands the nature of the questions, and will automatically build the model (or models, if appropriate) that best correspond to the question at-hand, and return the results to the user.

In some embodiments, the present invention has the means to scan through data in subsequent queries, and generates sequences of questions about the user's data, such as 1.) “Find patients admitted with Cancer since last month”, 2.) What patients had an abnormal insulin level?” 3.) “Show me BMI vs. Age”. In the graphical user interface presented to the user, the user can swipe left to reveal a subset of query 1., and if there is only one question afterwards, the system can accept a swipe to the right or top of the user interface. The purpose of this method is to easily navigate to see how information is filtered out in subsequent steps or “stitched in” if it must be joined from another data source.

In some embodiments of the present invention, a touch based natural language processing experience is provided, such as swiping or selecting a statement. For touch based devices, typing is tedious, and a different approach to sentence building is required to efficiently interact with users. The user touches a word which grows a tree to the right to continue building the sentence. In this fashion, an analytical statement is built in either a series of clicks or one continuous swipe of a finger that goes across the criterion required and searches formatted expressions from the language processing database. So, with a single swipe of a finger, a user can launch optimization, math modeling and/or other statistics.

In some embodiments of the present invention, a means to select outliers from a touch experience is provided. From a two-or-three dimensional plot, a user takes their finger and drags it through the required space (or simply touches an individual point) and the system automatically reverse-engineers the surface that would have corresponded to an algebraic expression that is then turned into a query to set-aside exemplars (points) in the plot into a new subset.

In some embodiments of the present invention, a means to automate clustering is provided. A user touches their finger anywhere on a two-or-three dimensional plot, and can initialize a new centroid for clustering (under where your finger was in the two-or-three dimensional space). For 3 dimensional plots, the system also takes into account azimuth and elevation as projections through the 3-D space where the user touched the screen, and the system will place a new clustering centroid somewhere along that projection axis.

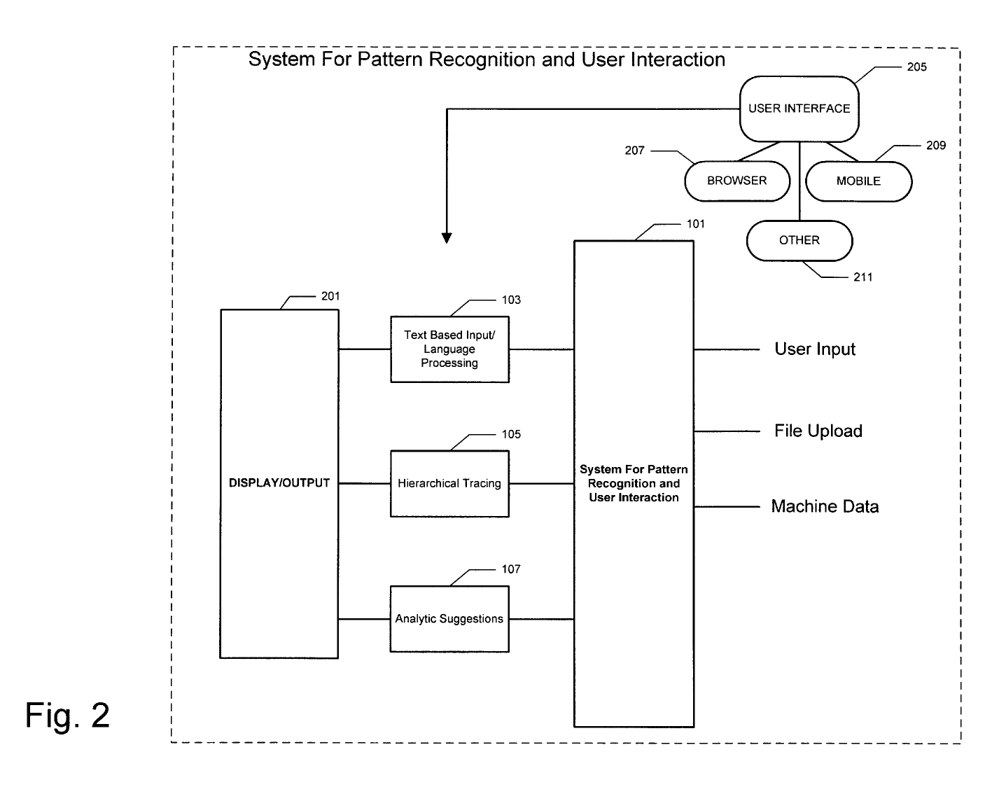

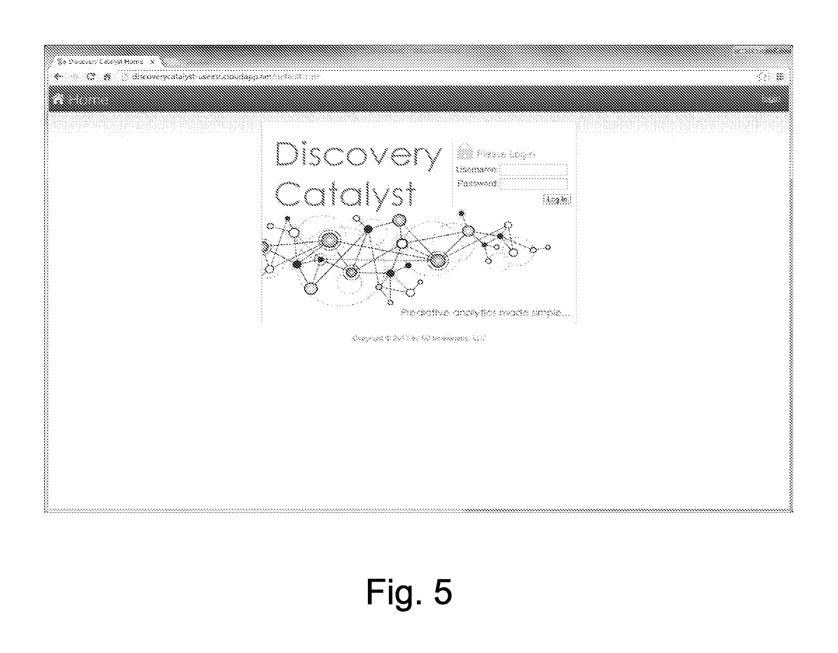

Turning now to FIG. 2, an input output diagram of the system for pattern recognition and user interaction is depicted. The fundamental components of the system for pattern recognition and user interaction 101 including text such as, for example, free form text, and language processing such as, for example, natural language processing 103, hierarchical tracing 105, and analytic suggestions 107, are depicted. Each of these fundamental components are provided as output to a display 201 such as a monitor, liquid crystal display, plasma display, light emitting diode display, cathode ray tube (CRT) display, or the like. Each of these fundamental components will be depicted in further detail by way of the sequence of screenshots provided in FIGS. 5-33 contained herein. As is evident from these screenshots, each has a user interface component 205 that may be accessed and operated by way of an internet or network browser 207, a mobile device 209, or other electronic and software based devices 211. The system for pattern recognition and user interaction requires data for operation. The data input may be in the form of user input by way of a keyboard, mouse, touch screen, or the like. In addition, data files may be uploaded and stored in memory for subsequent analysis and processing. Data files may be database files, spreadsheet files, text files, text files with appropriate delimiting, and the like. Further, machine data may be fed directly into the system for pattern recognition and user interaction, or may be stored in memory (temporary or permanent) and then transferred to the system for pattern recognition and user interaction. Machine data may include data from sensors, detectors, monitoring devices, computing devices, and the like.

The computer-based system for pattern recognition and user interaction comprises a computer having a processor, memory, and access to computer readable media; a computer program stored on computer readable media comprising a language processing component, a hierarchical tracing component, and a data input function; a mathematical model stored on computer readable media for application to data that is input through the data input function on the computer program, where the mathematical model creates a numeric or graphical output on a computer monitor that has a hierarchical construct that can be modified through user input of a hierarchy object selection and a text query; a user input device; a user interface displayed on a computer monitor for interaction with said computer program; and a network connection between the computer and a computer network for allowing remote access to the computer program.

In some embodiments of the present invention, the computer-based system for pattern recognition and user interaction comprises a computer having a processor, memory, and access to computer readable media; a computer program stored on computer readable media comprising a language processing component, an analytic suggestions component and a data input function; a mathematical model stored on computer readable media for application to data that is input through the data input function on the computer program, where the mathematical model creates a numeric, text or graphical output on a computer monitor that has a hierarchical construct that can be modified through user input of a hierarchy object selection and a text query; a user input device; a user interface displayed on a computer monitor for interaction with said computer program; and a network connection between the computer and a computer network for allowing remote access to the computer program.

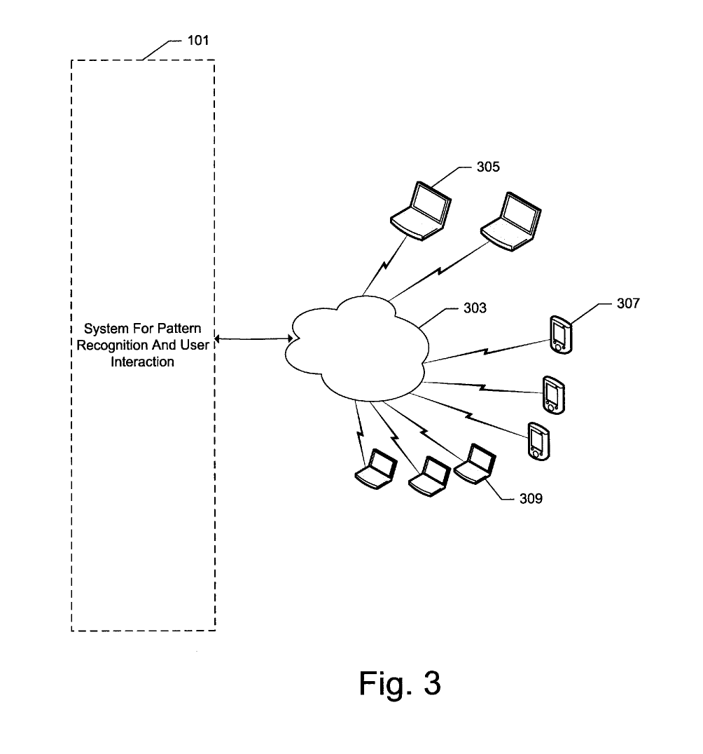

FIG. 3 is an exemplary network diagram of the present invention that depicts the system for pattern recognition and user interaction 101. A network 303 such as the internet may be used to access the system for pattern recognition and user interaction by way of devices such as desktop computers 305, handheld devices such as smart phones, personal digital assistants, tablet devices, and the like, or laptop computers 309. FIG. 3 may be an overly simplified representation of a typical network used with the system for pattern recognition and user interaction, as the network may contain additional complexity, hardware, software, and network components not depicted.

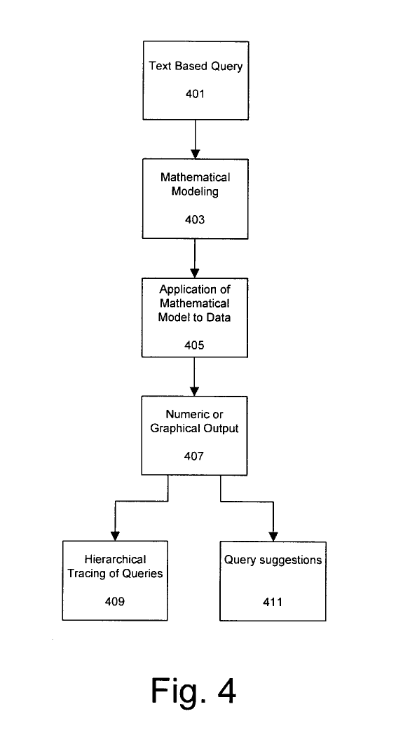

FIG. 4 is a flowchart depicting a typical input to output process and related method of the system for pattern recognition and user interaction. As herein described and depicted by the screenshots and figures attached, a text query 401 is entered by a user. This query contains the question or questions that the user wishes to answer regarding the data that has been loaded into the system. Once the text is entered, it is converted by the system into computer instructions and mathematical modeling 403 occurs. The mathematical model acts on input data based on user selection of an object where the selected object specifies a subset of the input data. In some embodiments of the present invention, the mathematical model further acts on a created subset of input data based on user input of a user query. The object is provided on a computer display in the form of a hierarchical display or tracing. The mathematical model is then applied to the data that has been loaded into the system in step 405. The answer to the query posed by the user is then generated as numeric or graphical output in step 407 and may be displayed on a computer display or the like. The queries that have been generated by the user are then displayed as a hierarchical tracing of queries in step 409 to allow the user to visualize the back and forth interrogation and dialogue that has taken place with the user through a series of user queries. This hierarchical tracing is displayed on a computer display or the like by way of a series of descriptive boxes or blocks that are interconnected by lines such that a tree or similar geometric hierarchical representation is displayed. Further, the system for pattern recognition and user interaction will generate query suggestions in step 411 that will prompt the user to consider various “what if” scenarios to ensure that all of the necessary questions regarding the data have been properly answered.

In accordance with one embodiment of the present invention, a method for pattern recognition and user interaction comprises the steps of providing input data on a computer having a processor, memory and computer readable media and storing said input data on the computer readable media; applying a mathematical model to the input data on the computer; receiving on the computer through a human interface device a text based question; converting the text based question to a machine language query on the computer; applying the machine language query to the input data on the computer to obtain a subset of the input data; presenting the question and the obtained input data subset as an answer in a hierarchical object on a computer display; providing on the computer a means for receiving a further text based question directed at the input data subset; converting the further text based question to a machine language query on the computer; applying the machine language query to the input data subset on the computer to obtain a further subset of the input data; presenting the question and the obtained further subset of the input data subset as an answer in a further hierarchical object on the computer display; and linking the hierarchical objects with linear traces that provide a visual representation of questions being asked of information provided as an answer in a previous object.

In some embodiments of the present invention, the method for pattern recognition and user interaction further comprises the step of selecting an object on the computer that results in the selected object being displayed on a computer monitor with an appearance that is different than non-selected objects. The selected object may, for example, change color, change shading, change outline, change line weight, change shape, move, oscillate, rotate, or the like.

In some embodiments of the present invention, the method for pattern recognition and user interaction further comprises the step of creating a subset of the input data based on the selection of an object.

In some embodiments of the present invention, the method for pattern recognition and user interaction further comprises the step of prompting a user with query suggestions on the computer display to encourage a user to consider various questions regarding input data.

FIG. 5 is a screenshot depicting a login page of the system for pattern recognition and user interaction where a user is prompted for their username and password. In some embodiments of the present invention, further or alternative authentication may be employed.

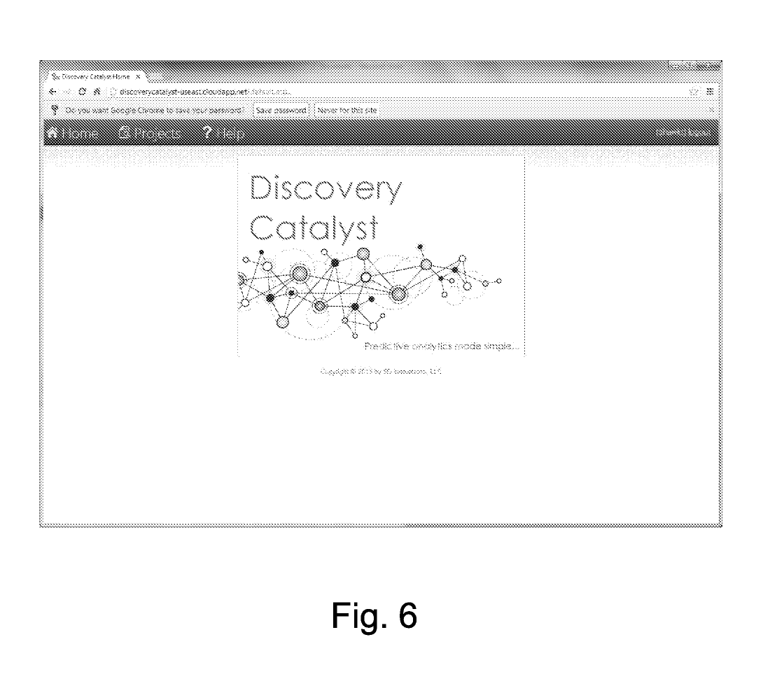

FIG. 6 is a screenshot depicting a home page of the present invention where projects may be selected from a top menu item.

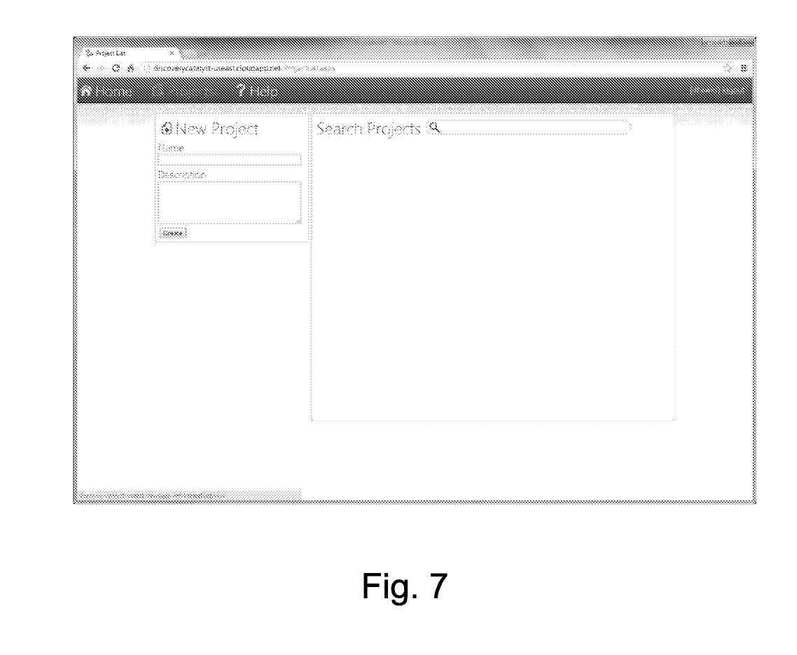

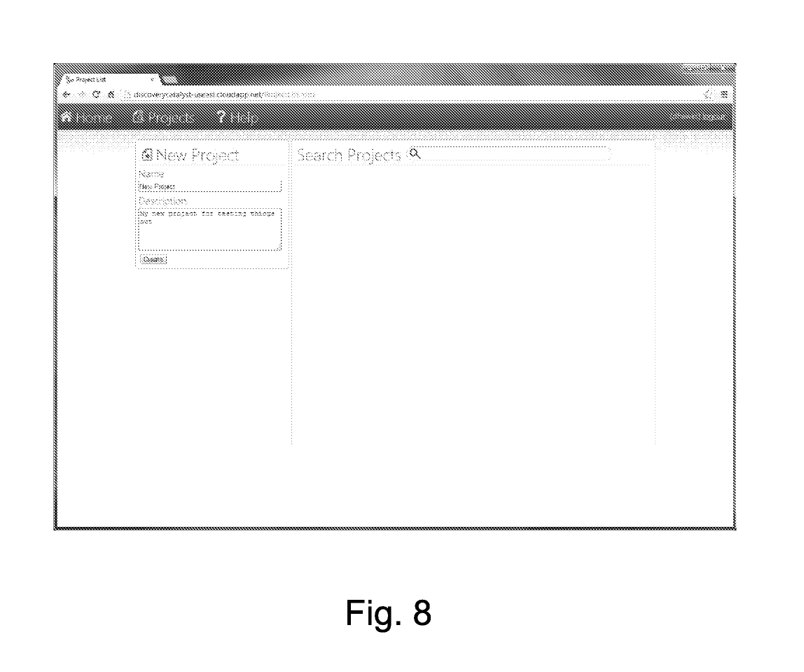

FIG. 7 is a screenshot depicting a project creation page that would be displayed once a user selects projects from a menu. The creation of a new project prompts the user for a project name as well as a description of the project. Further, existing projects may be searched. A project is any data set that is to be queried or otherwise investigated, analyzed, interrogated, processed, changed, transformed, modeled, or the like. In some embodiments of the present invention, projects may also simply be a set of data to be analyzed. FIG. 8 is a screenshot depicting data entry into the project creation page.

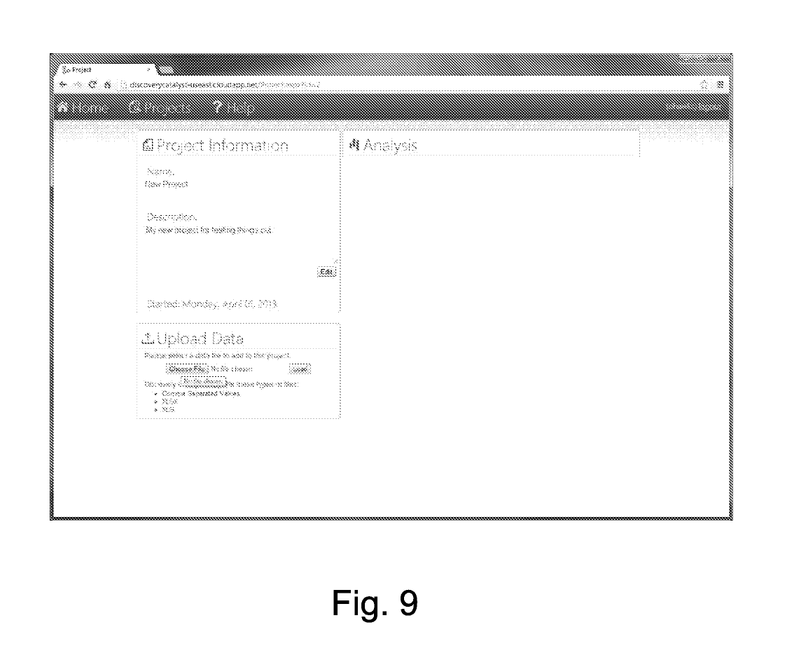

FIG. 9 is a screenshot depicting the selection of a data source file. From this screen a data file may be selected and uploaded, and an analysis window may be opened.

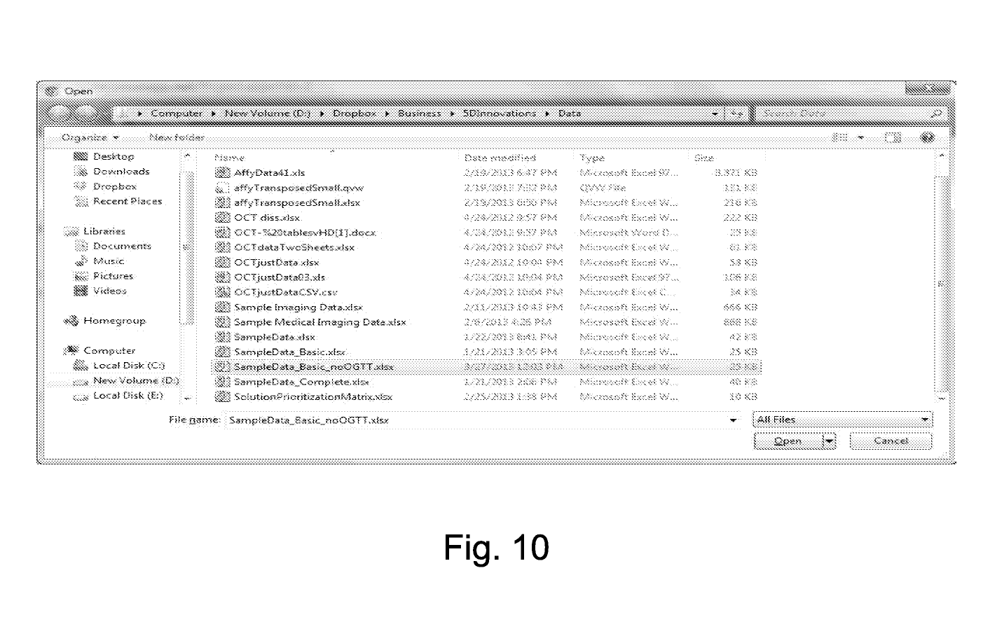

FIG. 10 is a screenshot depicting the selection of a specific data source file by browsing through files and folders. To select a specific data file, the file name is selected by clicking, touching, or otherwise highlighting and entering the specific data file name so requested.

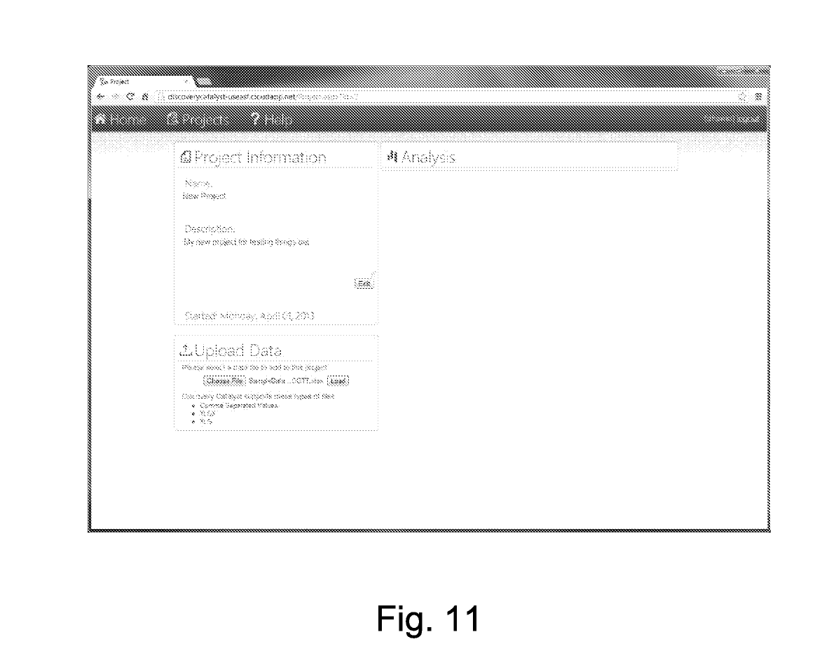

FIG. 11 is a screenshot depicting the data source file being selected and uploaded for further analysis.

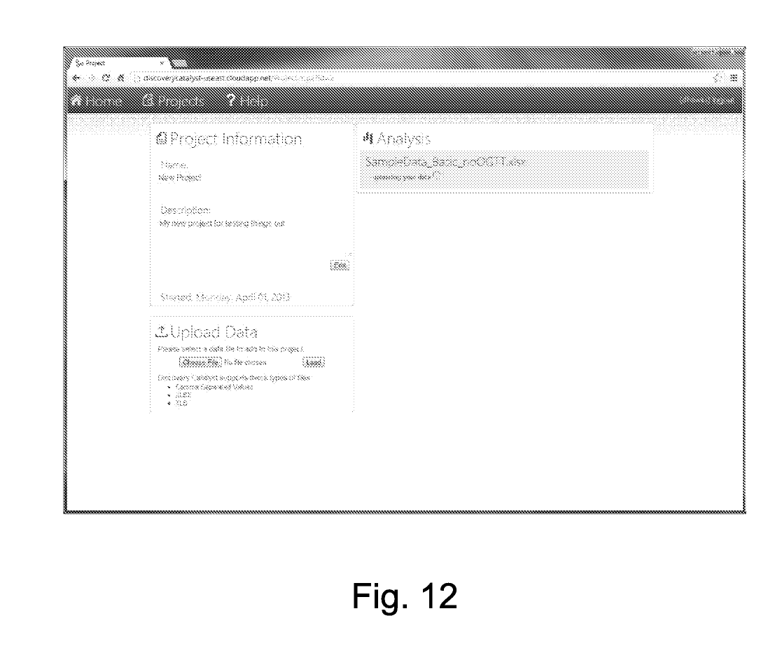

FIG. 12 is a screenshot depicting the data source file being uploaded. The file name of the data file so selected can be seen under the analysis window.

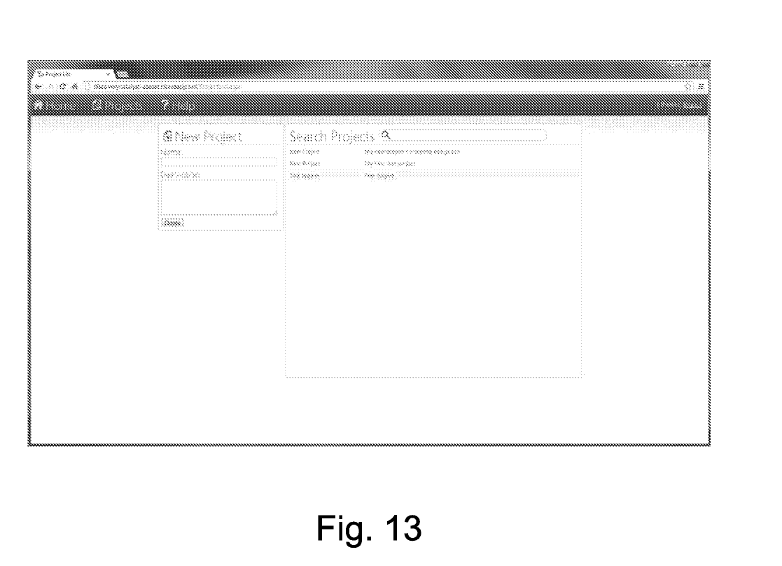

FIG. 13 is a screenshot depicting the data source file after upload, and ready for analysis. Various projects can be seen listed under the search projects window.

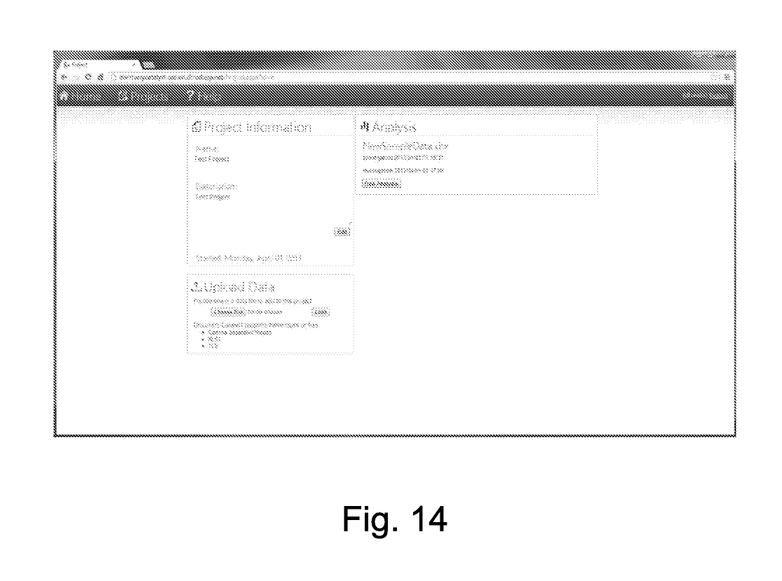

FIG. 14 is a screenshot depicting a project analysis selected. The project information such as the project name and description can be seen displayed under the project information window. Under the analysis window, the name of the data file can be seen along with identifying information related to several analyses that were conducted. From this window, a new analysis may be conducted using the new analysis button.

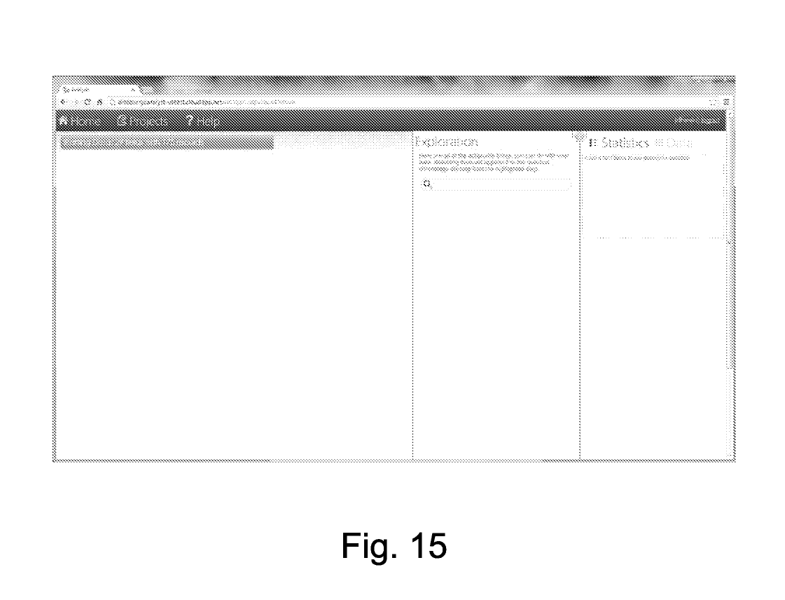

FIG. 15 is a screenshot depicting data statistics selected. Analysis opportunities and data statistics are automatically displayed upon selection.

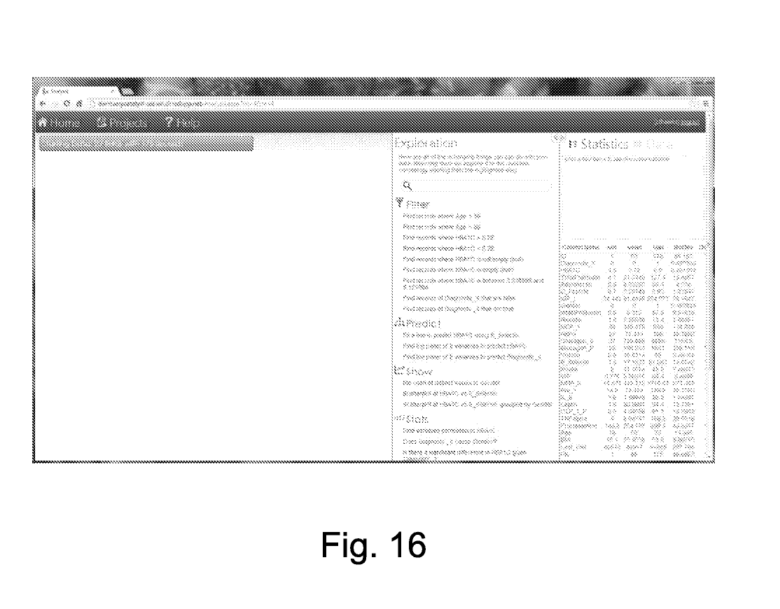

FIG. 16 is a screenshot depicting analysis opportunities and data statistics. Data from the selected data set is automatically depicted. Under the exploration window, text can be entered to initiate queries and retrieval of information. Suggestions for additional queries can also be seen. Suggestions for additional data filtering can be seen under the heading Filter. Under the heading Predict various predictive models can be requested such as a linear regression for selected data. Under the Show heading, various charts and graphs are suggested and may be selected or requested. Additional statistical suggestions are also found under the heading Stats. On the right side of the screenshot, the data set is displayed under the Statistics heading.

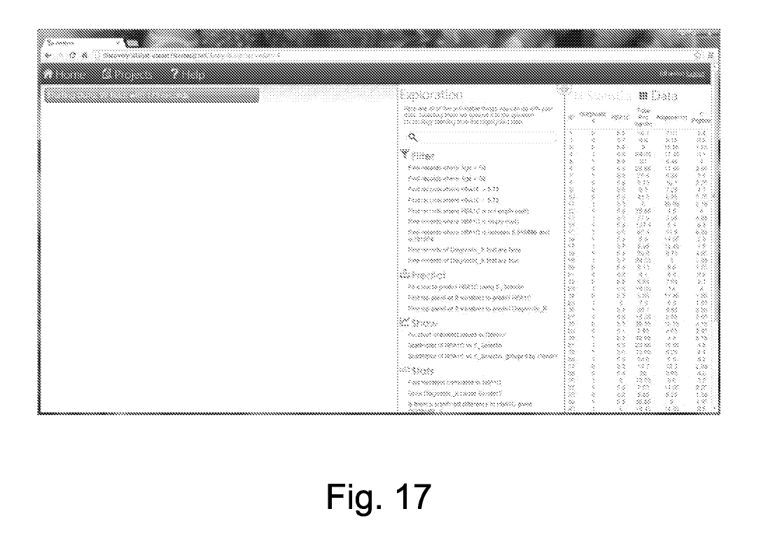

FIG. 17 is a screenshot depicting data being displayed with a chosen data set. On the right side of the screenshot, under Data, there is shown a view of raw data.

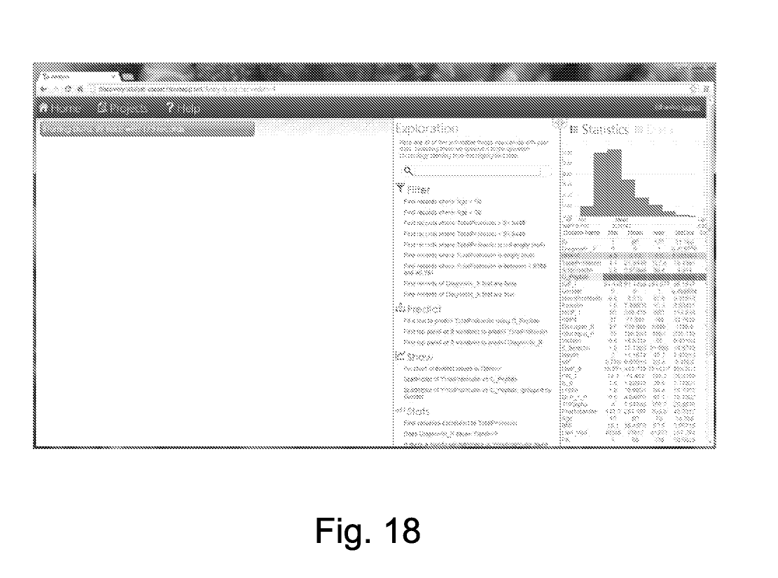

FIG. 18 is a screenshot depicting statistics for a specific parameter. In this example, a bar chart is shown along with the specific statistics listed below.

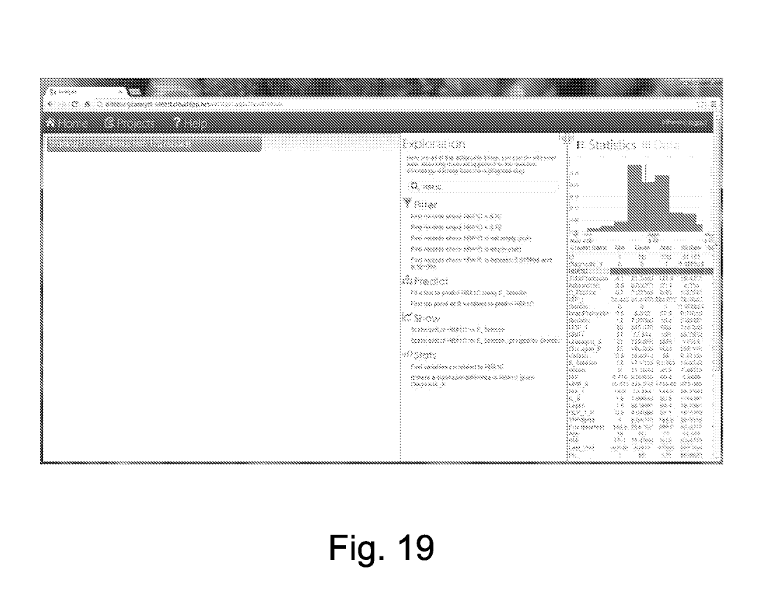

FIG. 19 is a screenshot depicting statistics of a particular parameter chosen. In this example, the suggestions are dynamically changing based on the text and language inputs.

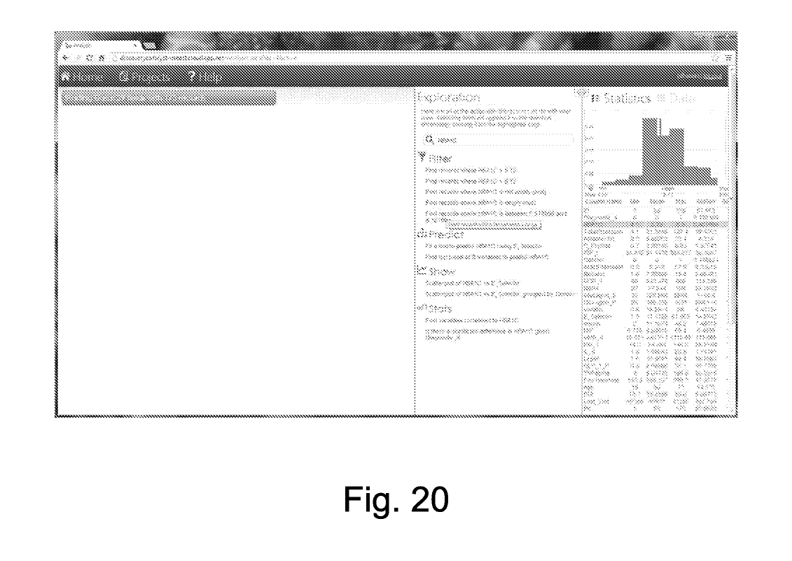

FIG. 20 is a screenshot depicting records that fall between a range. There are various suggestions for the range, and a user may select one of the suggestions or elect to enter a new one.

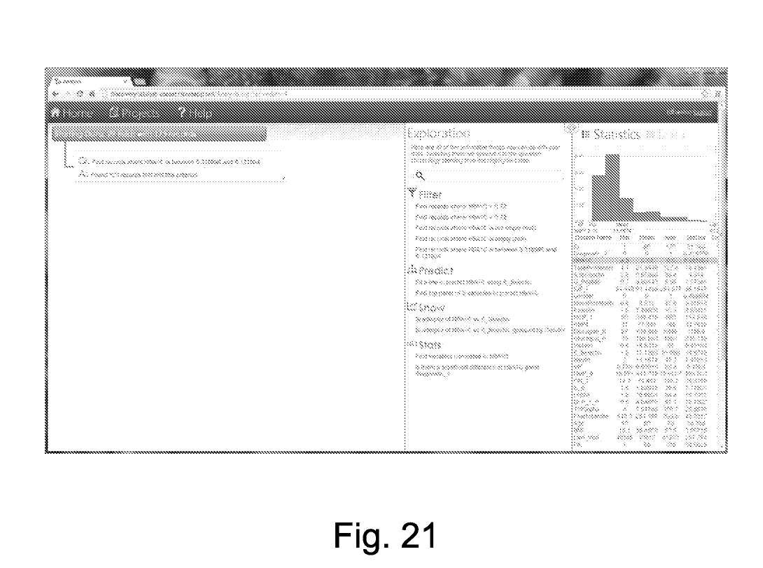

FIG. 21 is a screenshot depicting the results of records falling between a range that has been specified by a user. As seen in FIG. 21, various ranges and other suggestions are provided by the system. A hierarchical object can be seen with a question (Q:) and answer (A:) format with a linear trace between the starting data object and the hierarchical object displayed on the left side of the screenshot of FIG. 21.

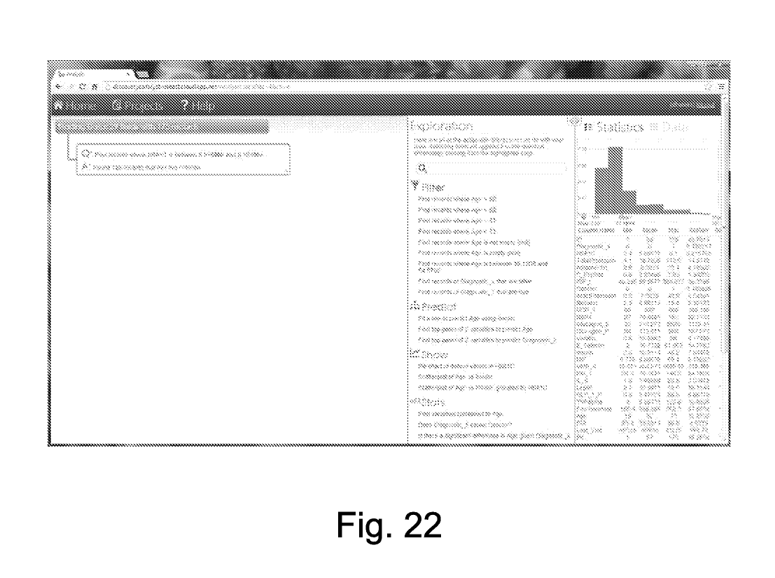

FIG. 22 is a screenshot depicting records within a range and new exploration opportunities. The new suggestion opportunities are listed under the Exploration window. The start of hierarchical tracing can also be seen in the left portion of the screenshot where a branch or trace is connected from the starting data indicator to a box that contains both the question (“Q:”) and the answer (““A:”). As will be depicted in subsequent figures, the tracing will continue for each interaction between the user and the system, and will also depict, in some embodiments of the present invention, graphs or other representations of the data or the question or answer posed.

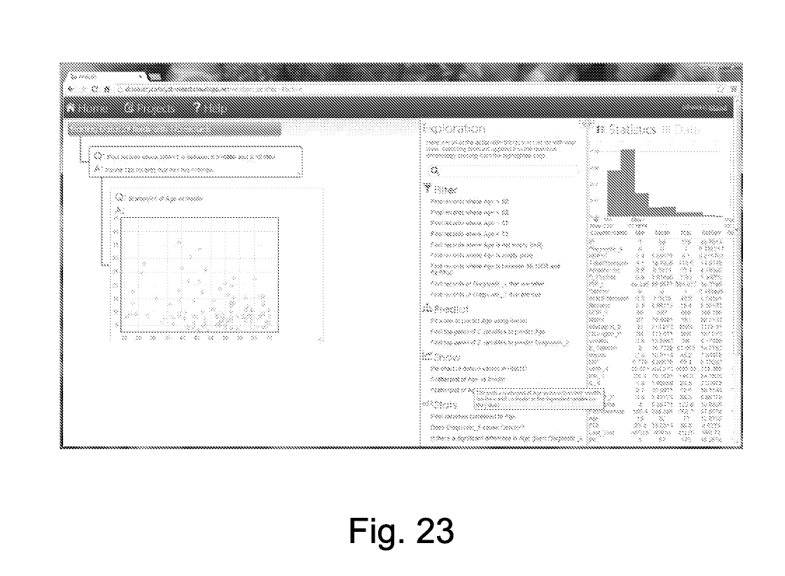

FIG. 23 is a screenshot depicting auto-plotting of data. As depicted, the plot may appear in the hierarchical tracing and within a hierarchical object as an answer to a query posed by a user. In this particular example, the plot is a scatter plot, but may be any of a variety of plots or graphs. A user may enter their specific plot requirements under Exploration using text such as, for example, free form text.

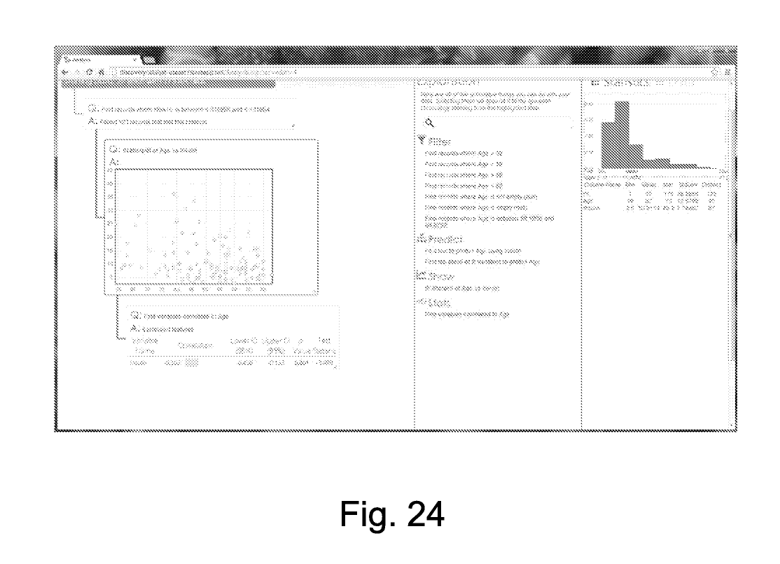

FIG. 24 is a screenshot depicting auto generated exploration opportunities. In addition, a further branch from the hierarchical tracing is generated when a user enters another query related to the previous outcome or answer. The answer is provided in a question and answer dialog box, and may contain numerical as well as graphical outcomes. The hierarchical tracing provides for mapping and visual representation of the ongoing interrogation by a user. In some embodiments of the present invention, the hierarchical tracing begins with a box representing the initial data set, and branches to a first question and answer dialogue box, which then branches to a second question and answer dialogue box where the branch or tracing ties back to the data, result, or dialogue that it refers to. The hierarchical tracing is displayed on a computer display or the like and may continue for many branches and levels. Each hierarchical object can be selected by the user for further processing and interrogation.

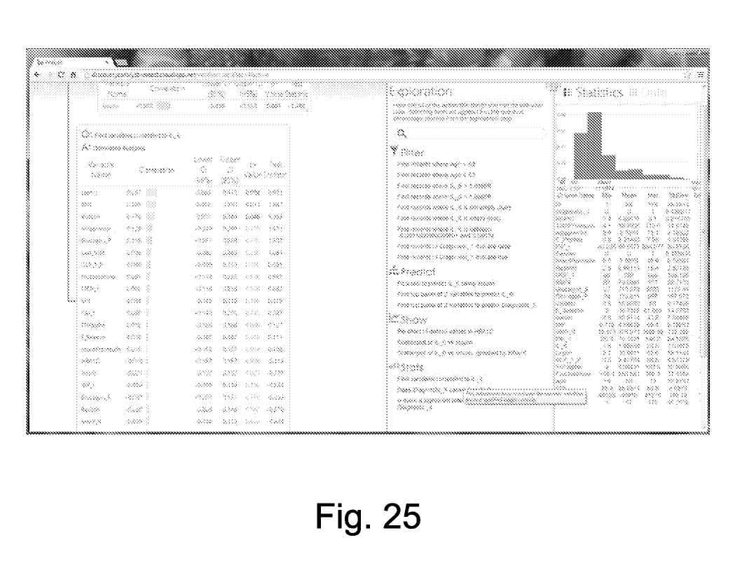

FIG. 25 is a screenshot depicting automatic finding of correlated items. The correlated items stem from a query posed by a user, and may contain suggestions or additional information to supplement or enhance the original query.

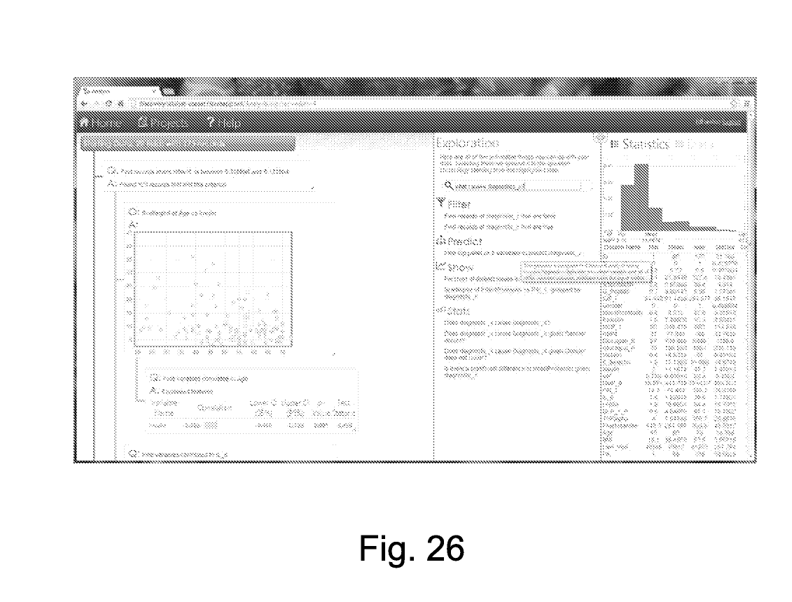

FIG. 26 is a screenshot depicting automatic performance of a complex modeling prognostic. Again, hierarchical tracing is employed.

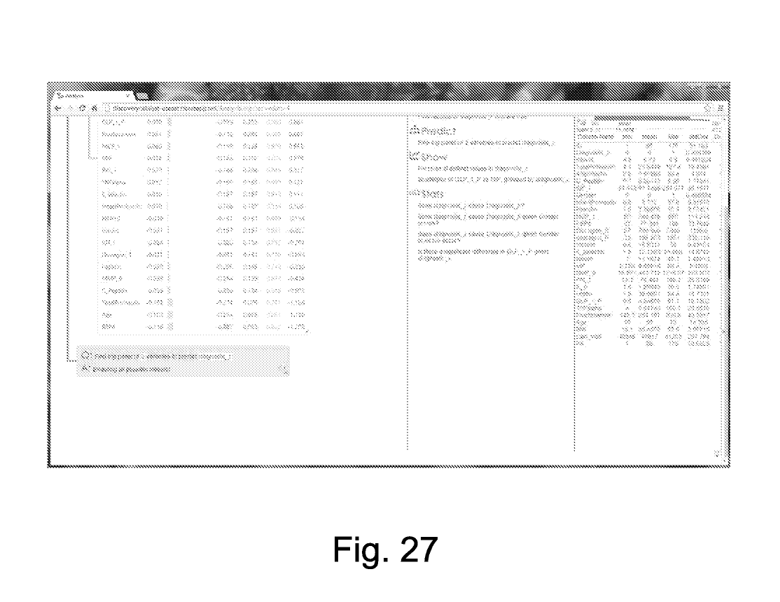

FIG. 27 is a screenshot depicting computation of a predictive analytics prognostic. In this example, the question posed by the user relates to predicting a diagnostic. Other predictive analytics queries as well as underlying models and techniques may be employed in some embodiments of the present invention.

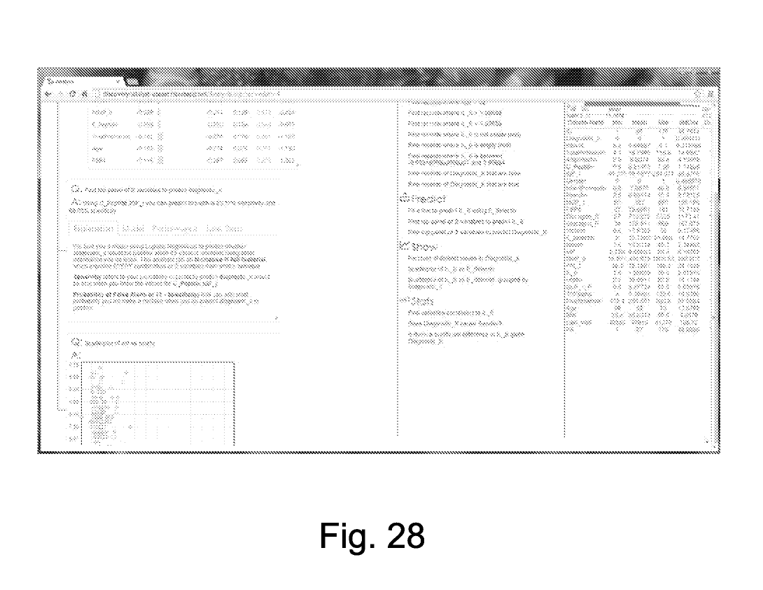

FIG. 28 is a screenshot depicting an explanation of predictive analytics. In some embodiments of the present invention, an explanation of the analytical technique that has been used is provided for under an explanation tab. Further details regarding the model itself may be found under a model tab. In addition, performance data such as graphs and statistics as well as suggested next steps in the interactive analysis are suggested, similar to the way in which analytic suggestions are made in the system.

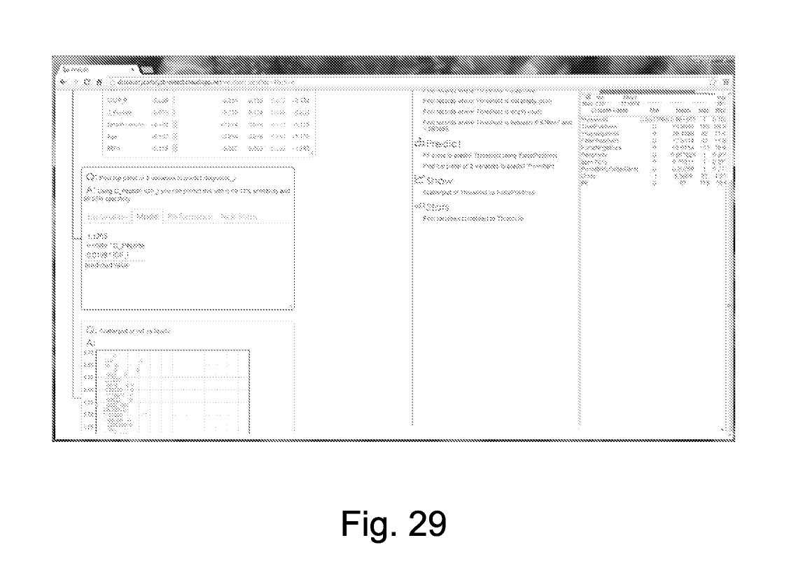

FIG. 29 is a screenshot depicting the computation of predictive analytics model parameters. In FIG. 29, the underlying model is provided by selection of the model tab in the specified question and answer dialogue box. The hierarchical tracing can be seen with the model information provided as a drop down in a question and answer dialogue box.

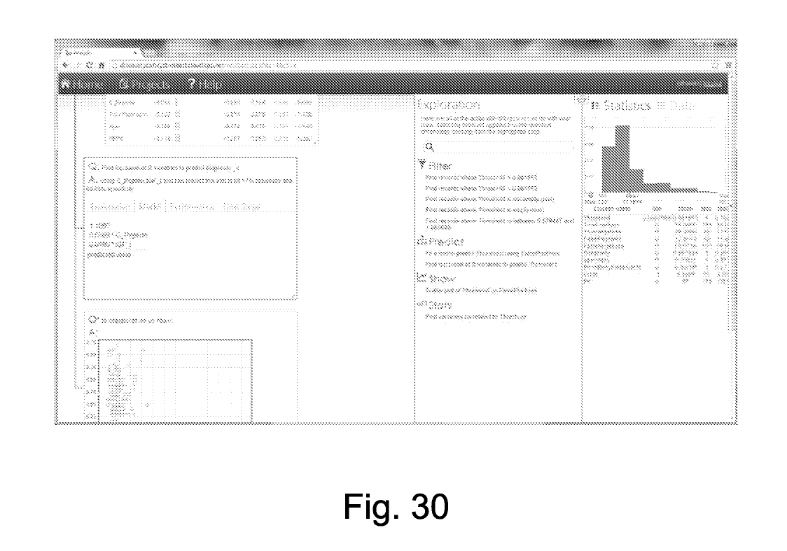

FIG. 30 is a screenshot depicting predictive analytics statistics that are displayed in the statistics window in FIG. 30.

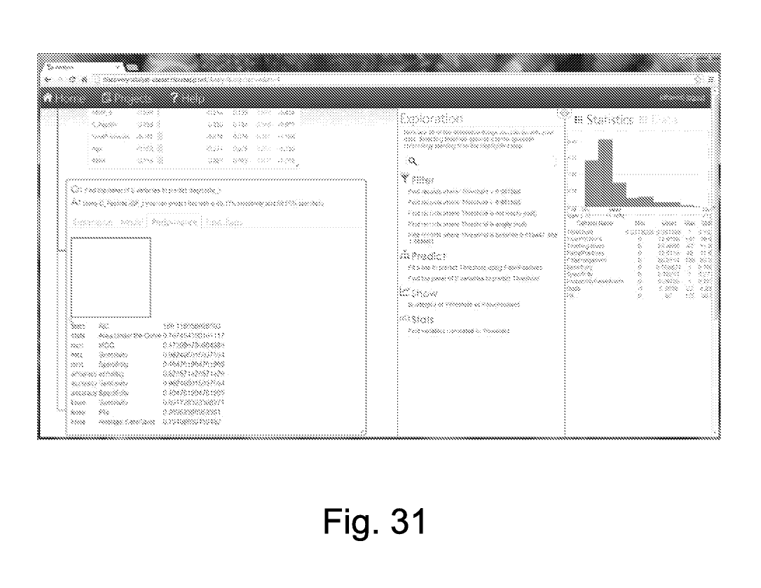

FIG. 31 is a screenshot depicting performance statistics of a predictive analytics model. In the specified question and answer dialogue box, the Performance tab is selected and a graph with underlying performance data is displayed in the question and answer dialogue box.

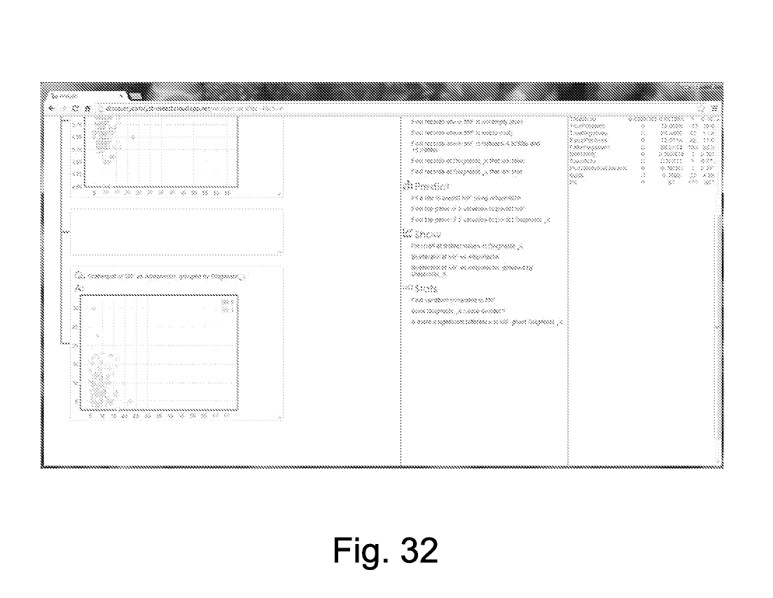

FIG. 32 is a screenshot depicting an automated “group by” plot where a user, in this example, requested a scatter plot grouped by a diagnostic criteria. The scatter plot is then depicted in the specified question and answer dialogue box.

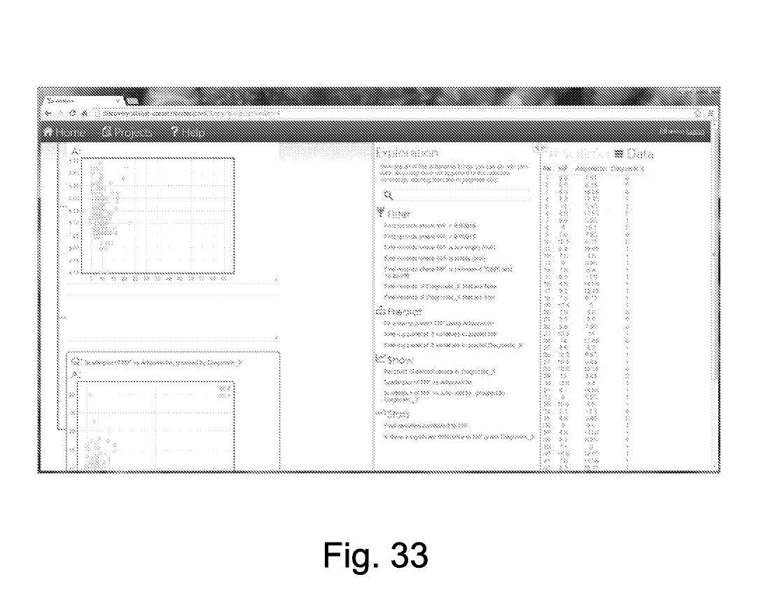

FIG. 33 is a screenshot depicting automated “group by” data in the form of a scatter plot. Other graphical and visual representations of such a “group by” request include, but are not limited to, graphs, charts, data listings, and the like. Again, hierarchical tracing can be seen in FIG. 33.

The screenshots as presented herein are exemplary only, and are not to be considered limitations, but rather, examples to allow one skilled in the art to make and use the present invention. It is, therefore, apparent that there has been provided, in accordance with the various objects of the present invention, a system and method for pattern recognition and user interaction. While the various objects of this invention have been described in conjunction with preferred embodiments thereof, it is evident that many alternatives, modifications, and variations will be apparent to those skilled in the art. Accordingly, it is intended to embrace all such alternatives, modifications and variations that fall within the spirit and broad scope of this specification, claims and drawings herein.

What is claimed is:

1. A computer-based system for pattern recognition and user interaction comprising:
a computer having a processor, memory, and access to computer readable media;
a computer program stored on computer readable media comprising a language processing component, an analytic suggestions component, and a data input function;
a mathematical model stored on computer readable media for application to data that is input through the data input function on the computer program, where the mathematical model creates a numeric, text or graphical output on a computer display that has a hierarchical construct that can be modified through user input of a hierarchy object selection and a text query;
a user input device;
a user interface displayed on a computer display for interaction with said computer program; and
a network connection between the computer and a computer network for allowing remote access to the computer program.

2. The system of claim 1, wherein the computer program further comprises a hierarchical tracing component.

3. The system of claim 1, wherein the language processing component is a free form text natural language processing component.

4. The system of claim 1, wherein the hierarchical tracing component creates a series of objects that contain both a question and an answer, the objects being connected through linear traces that provide a visual representation on a computer display of questions being asked of information provided as an answer in a previous object, creating a geometric hierarchical representation of a question and answer dialogue between a user and the system for pattern recognition and user interaction.

5. The system of claim 1, wherein the language processing component converts a user's text entry into a query that targets input data.

6. The system of claim 5, wherein the query is displayed as a suggestion in a created object.

7. The system of claim 4, further comprising a hierarchical object selector where a user takes an action to select a hierarchical object that results in the selected hierarchical object being displayed on a computer display with an appearance that is different than non-selected hierarchical objects.

8. The system of claim 7, wherein the mathematical model acts on input data based on user selection of an object where the selected object specifies a subset of the input data.

9. The system of claim 8, wherein the mathematical model further acts on the created subset of the input data based on user input of a user query.

10. The system of claim 4, further comprising an answer displayed within an object wherein said answer is selected from the group consisting of a graph, a table, a mathematical expression, the word yes, the word no, text, numbers, or symbols.

11. The system of claim 1, further comprising a query suggestion component to prompt a user to consider various questions regarding input data.

12. The system of claim 11, wherein the query suggestion component further comprises filter suggestions.

13. The system of claim 11, wherein the query suggestion component further comprises plots and trends suggestions.

14. The system of claim 11, wherein the query suggestion component further comprises statistics suggestions.

15. The system of claim 11, wherein the query suggestion component further comprises prediction suggestions.

16. A method for pattern recognition and user interaction, the method comprising the steps of:
providing input data on a computer having a processor, memory and computer readable media and storing said input data on the computer readable media;
applying a mathematical model to the input data on the computer;
receiving on the computer through a human interface device a text based question;
converting the text based question to a machine language query on the computer;
applying the machine language query to the input data on the computer to obtain a subset of the input data;
presenting the question and the obtained input data subset as an answer in a hierarchical object on a computer display;
providing on the computer a means for receiving a further text based question directed at the input data subset;
converting the further text based question to a machine language query on the computer;
applying the machine language query to the input data subset on the computer to obtain a further subset of the input data;
presenting the question and the obtained further subset of the input data subset as an answer in a further hierarchical object on the computer display; and
linking the hierarchical objects with linear traces that provide a visual representation of questions being asked of information provided as an answer in a previous object.

17. The method of claim 16, further comprising the step of selecting an object on the computer that results in the selected object being displayed on a computer display with an appearance that is different than non-selected objects.

18. The method of claim 16, further comprising the step of creating a subset of the input data based on the selection of an object.

19. The method of claim 16, wherein the input data subset is displayed as an answer displayed within a hierarchical object wherein said answer is selected from the group consisting of a graph, a table, a mathematical expression, the word yes, the word no, text, numbers, or symbols.

20. The method of claim 16, further comprising the step of prompting a user with query suggestions on the computer display to encourage a user to consider various questions regarding input data.

21. A hierarchical tracing user interface for display on a computer screen, the hierarchical tracing user interface comprising:
a text user input field;
a plurality of hierarchical objects interconnected through linear traces;
each hierarchical object having a geometric shape and containing a prompt indicating a question and a prompt indicating an answer;
wherein information obtained from text entered in the user input field is displayed after the prompt indicating a question in at least one hierarchical object and
a subset of input data is displayed after the prompt indicating an answer in at least one hierarchical object; and
wherein the interconnection of hierarchical objects containing a question component and an answer component with linear traces provides a visual representation of questions being asked of information provided as an answer in a previous object.

22. A computer-based system for pattern recognition and user interaction comprising:
a computer having a processor, memory, and access to computer readable media;
a computer program stored on computer readable media comprising a language processing component, a hierarchical tracing component and a data input function;
a mathematical model stored on computer readable media for application to data that is input through the data input function on the computer program, where the mathematical model creates a numeric, text or graphical output on a computer display that has a hierarchical construct that can be modified through user input of a hierarchy object selection and a text query;
a user input device;
a user interface displayed on a computer display for interaction with said computer program; and
a network connection between the computer and a computer network for allowing remote access to the computer program.
